(19) United States
(12) Patent Application Publication
(10) Pub. No.: US 2011/0151202 A1
(43) Pub. Date: Jun. 23, 2011

(54) Controllable Placement of Liquid Adhesive on Substrate

(76) Inventors: Casey J. FEINSTEIN, San Jose, CA (US); Kuo-Hua Sung, Sunnyvale, CA (US); John Z. Zhong, Cupertino, CA (US)

(21) Appl. No.: 12/641,851

(22) Filed: Dec. 18, 2009

(51) Int. Cl. B32B 3/10; B05D 5/10; B05D 3/14; B05D 3/06; B05C 11/00

(52) U.S. Cl. 428/195.1; 427/207.1; 427/532; 427/487; 427/510; 118/600

(57) ABSTRACT

Controllable placement of a liquid adhesive on a substrate to confine the adhesive to a desired area of the substrate is disclosed. A controllable placement method can include dispensing a liquid adhesive into a designated area on a surface of a substrate, controllably confining the dispensed liquid adhesive to the designated area, and curing the confined liquid adhesive. The dispensed liquid adhesive can be controllably confined using various techniques, such as electrical repulsion, electrical attraction, capacitance, electrowetting, light curing, adhesive attracting-repulsing coatings, and substrate topography. A substrate having a controllably placed liquid adhesive thereon can be incorporated into electronic devices, such as a mobile telephone, a digital media player, or a personal computer.

### FIELD

This relates generally to substrates and, more particularly, to controllable placement of a liquid adhesive on a substrate.

### BACKGROUND

Electronic devices can generally include at least one substrate with another substrate and/or electrical components adhered thereto. Conventional fabrication of the substrates can involve applying an adhesive to a surface of a substrate and using the applied adhesive to adhere another substrate and/or electrical component to the substrate surface. A liquid adhesive is preferred because of its flowability, which allows the adhesive to easily cover many different substrate configurations. However, the adhesive's flowability can also be problematic because of the difficulty in stopping the adhesive from overflowing the desired coverage area.

To solve this problem, dams have been built around desired coverage areas on a substrate surface to hold the adhesive while the adhesive solidifies. However, dams are not suitable in some applications, e.g., the substrate topography can make dam placement difficult or the dam can cause undesirable discontinuities in the substrate surface. Moreover, during liquid adhesive dispensing, the dam can trap air pockets, causing bubbles or voids in the solidified adhesive, which can interfere with performance of the substrate device. Furthermore, the use of dams can require additional equipment, time, and expense for building and, in some instances, later removing the dams. When a substrate is curved or non-planar, these problems can exacerbate.

### SUMMARY

This relates to controllable placement of a liquid adhesive on a substrate to confine the adhesive to a desired area of the substrate. A method can include dispensing a liquid adhesive into a designated area on a surface of a substrate, controllably confining the dispensed liquid adhesive to the designated area, and curing the confined liquid adhesive. The dispensed liquid adhesive can be controllably confined using various techniques, such as electrical repulsion, electrical attraction, capacitance, electrowetting, light curing, adhesive attracting-repulsing coatings, and substrate topography. Controllable placement can advantageously save time, equipment, and cost, while providing a continuous, smooth adhesive to hold together device substrates of various configurations.

### BRIEF DESCRIPTION OF THE DRAWINGS

FIGS. 1a and 1b illustrate exemplary structures having substrates held together by a liquid adhesive according to various embodiments.

FIG. 2 illustrates an exemplary method for controlling placement of a liquid adhesive on a substrate according to various embodiments.

FIGS. 3a and 3b illustrate an exemplary structure having a substrate with a liquid adhesive placed thereon using electrical repulsion according to various embodiments.

FIG. 4 illustrates an exemplary method for placing a liquid adhesive on a substrate using electrical repulsion according to various embodiments.

FIG. 5 illustrates an exemplary structure having a substrate with a liquid adhesive placed thereon using electrical attraction according to various embodiments.

FIG. 6 illustrates an exemplary method for placing a liquid adhesive on a substrate using electrical attraction according to various embodiments.

FIG. 7 illustrates an exemplary structure having a substrate with a liquid adhesive placed thereon using capacitance according to various embodiments.

FIG. 8 illustrates an exemplary method for placing a liquid adhesive on a substrate using capacitance according to various embodiments.

FIGS. 9a and 9b illustrate an exemplary structure having a substrate with a liquid adhesive placed thereon using electrowetting according to various embodiments.

FIG. 10 illustrates an exemplary method for placing a liquid adhesive on a substrate using electrowetting according to various embodiments.

FIG. 11 illustrates an exemplary structure having a substrate with a liquid adhesive placed thereon using light curing according to various embodiments.

FIG. 12 illustrates an exemplary method for placing a liquid adhesive on a substrate using light curing according to various embodiments.

FIG. 13 illustrates another exemplary structure having a substrate with a liquid adhesive placed thereon using light curing according to various embodiments.

FIG. 14 illustrates an exemplary structure having a substrate with a liquid adhesive placed thereon using laser curing according to various embodiments.

FIGS. 15a through 15c illustrate an exemplary structure having a substrate with a liquid adhesive placed thereon using total internal light reflection according to various embodiments.

FIG. 16 illustrates an exemplary method for placing a liquid adhesive on a substrate using total internal light reflection according to various embodiments.

FIGS. 17a through 17c illustrate another exemplary structure having a substrate with a liquid adhesive placed thereon using total internal light reflection according to various embodiments.

FIGS. 18a and 18b illustrate an exemplary structure having a substrate with a liquid adhesive placed thereon using hydrophilic and hydrophobic coating according to various embodiments.

FIG. 19 illustrates an exemplary method for placing a liquid adhesive on a substrate using hydrophilic and hydrophobic coating according to various embodiments.

FIGS. 20a through 20c illustrate an exemplary structure having a substrate with a liquid adhesive placed thereon using a movable mask according to various embodiments.

FIG. 21 illustrates an exemplary method for placing a liquid adhesive on a substrate using a movable mask according to various embodiments.

FIGS. 22a and 22b illustrate an exemplary structure having a substrate with a liquid adhesive placed thereon using topography of the substrate according to various embodiments.

FIG. 23 illustrates an exemplary method for placing a liquid adhesive on a substrate using topography of the substrate according to various embodiments.

FIGS. 24a and 24b illustrate an exemplary system having an integrated liquid dispenser and curing source for controllably placing a liquid adhesive on a substrate according to various embodiments.

FIG. 25 illustrates an exemplary system having a print screen for controllably placing a liquid adhesive on a substrate according to various embodiments.

FIG. 26 illustrates an exemplary mobile telephone having a substrate with a liquid adhesive controllably placed thereon according to various embodiments.

FIG. 27 illustrates an exemplary digital media player having a substrate with a liquid adhesive controllably placed thereon according to various embodiments.

FIG. 28 illustrates an exemplary computer having a substrate with a liquid adhesive controllably placed thereon according to various embodiments.

### DETAILED DESCRIPTION

In the following description of various embodiments, reference is made to the accompanying drawings which form a part hereof, and in which it is shown by way of illustration specific embodiments which can be practiced. It is to be understood that other embodiments can be used and structural changes can be made without departing from the scope of the various embodiments.

This relates to controllable placement of a liquid adhesive on a substrate to confine the adhesive to a desired area of the substrate. A controllable placement method can include dispensing a liquid adhesive into a designated area on a surface of a substrate, controllably confining the dispensed liquid adhesive to the designated area, and curing the confined liquid adhesive. The dispensed liquid adhesive can be controllably confined using various techniques, such as electrical repulsion, electrical attraction, capacitance, electrowetting, light curing, adhesive attracting-repulsing coatings, and substrate topography. Controllable placement can advantageously save time, equipment, and cost, while providing a continuous, smooth adhesive to hold together device substrates of various configurations. Unlike conventional methods, various embodiments need not build a dam on the substrate to confine the adhesive.

A liquid adhesive, as referred to herein, can include liquids, fluids, gels, pastes, suspensions, emulsions, and other flowable substances capable of adhering to one or more surfaces.

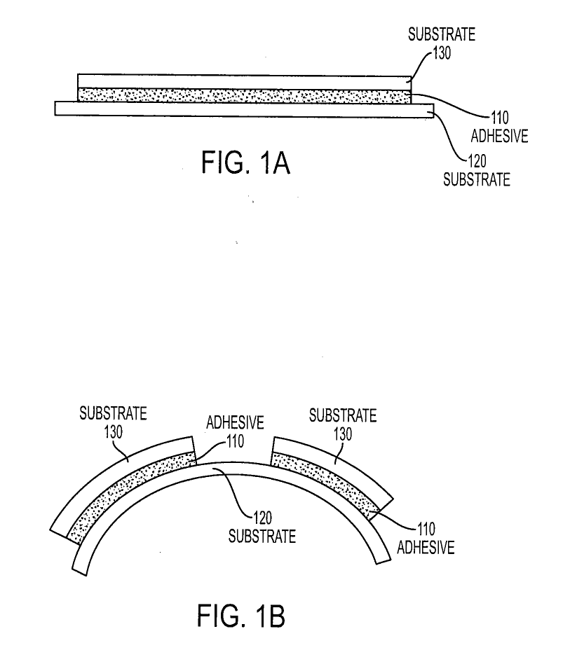

FIGS. 1a and 1b illustrate exemplary structures having substrates held together by cured liquid adhesive according to various embodiments. In the example of FIG. 1a, flat substrates 120 and 130 can have adhesive 110 controllably placed therebetween to hold the substrates together. In the example of FIG. 1b, curved substrates 120 and 130 can have adhesive 110 controllably placed therebetween to hold the substrates together. Placement of the adhesive 110 can be controlled so as to hold together substrates having various orientations, configurations, shapes, and the like. Other structures are also possible.

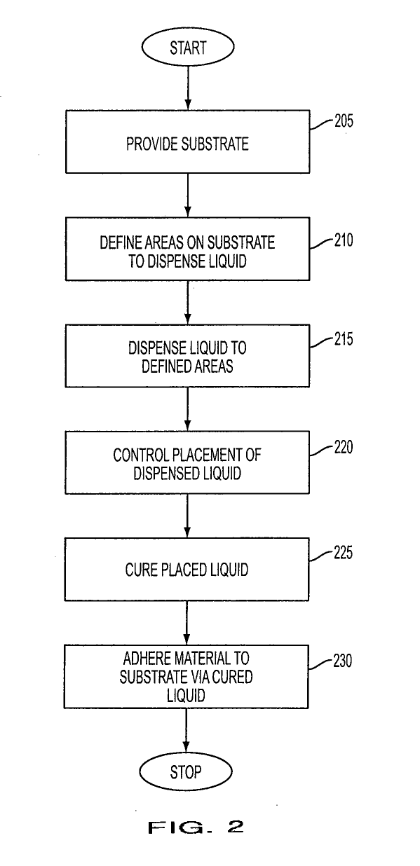

FIG. 2 illustrates an exemplary method for controlling placement of a liquid adhesive on a substrate according to various embodiments. In the example of FIG. 2, a substrate for a device can be provided (205). In some embodiments, the substrate can be glass, plastic, and the like. The substrate can be flat, curved, flexible, rigid, and the like. One or more areas on the substrate can be defined for placing liquid adhesive in order to hold another substrate or other material on the substrate (210). In some embodiments, the liquid adhesive can be water- or oil-based, conductive or dielectric, and so on, depending on placement needs. The liquid adhesive can be dispensed onto the substrate within the defined area(s) (215). Placement of the dispensed adhesive can be controlled so as to confine the adhesive to the defined area(s) (220). Various parameters of the adhesive, e.g., amount, temperature, pressure, flow, location, spread, timing, and the like, can be controlled either manually or automatically to ensure proper placement of the adhesive. After the liquid adhesive has been controllably placed in the defined area(s), the adhesive can be cured to ensure that there is no further movement (225). The liquid adhesive can be cured using various sources, e.g., electromagnetic radiation, heat, chemical reaction, coolant, and the like. A material, e.g., another substrate or other components of the device, can be placed on the cured adhesive to adhere to the underlying substrate (230).

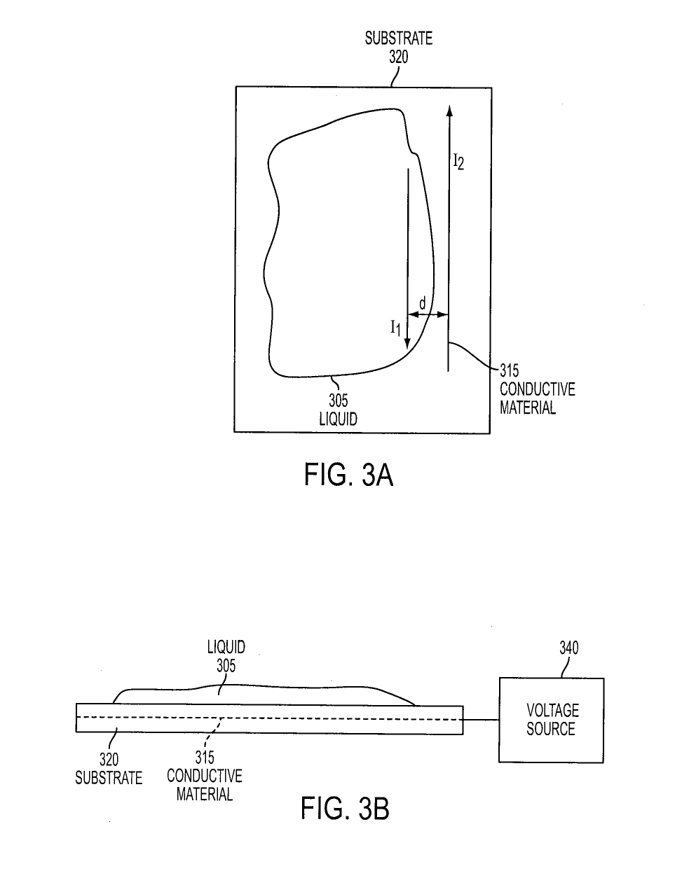

FIGS. 3a and 3b illustrate an exemplary structure having a substrate with a liquid adhesive placed thereon using electrical repulsion according to various embodiments. Electrical repulsion can involve transmitting electric current in opposite directions through proximate conductors, e.g., wires, traces, patterned thin film, layers, substances, etc., thereby generating a repulsive force between the conductors where the strength of the force can be a function of the distance d between the conductors. The closer the conductors, i.e., the smaller the distance d, the stronger the repulsive force keeping the conductors apart; whereas, the farther apart the conductors, i.e., the larger the distance d, the weaker the repulsive force. In the example of FIGS. 3a and 3b, electrical repulsion can be used to prevent a liquid adhesive from spreading beyond a desired area of a substrate.

Here, substrate 320 can include patterns of conductive material 315 on the substrate surface and/or embedded within the substrate for transmitting electric current. The patterns can define one or more areas on the substrate 320 within which to dispense conductive liquid adhesive 305. In this example, the patterns can include conductive material 315 around the border of the substrate 320 to define an area within which to dispense the adhesive 305. Voltage source 340 can drive electric current I₂ through the conductive material 315 in one direction and electric current I₁ through the conductive liquid adhesive 305 dispensed on the substrate 320 in the opposite direction. As the driven adhesive 305 spreads on the substrate 320 to within distance d of the driven conductive material 315, repulsive forces between the electric currents I₁ and I₂ can increase to an amount sufficient to stop the adhesive from spreading further, thereby confining the adhesive to the defined area on the substrate.

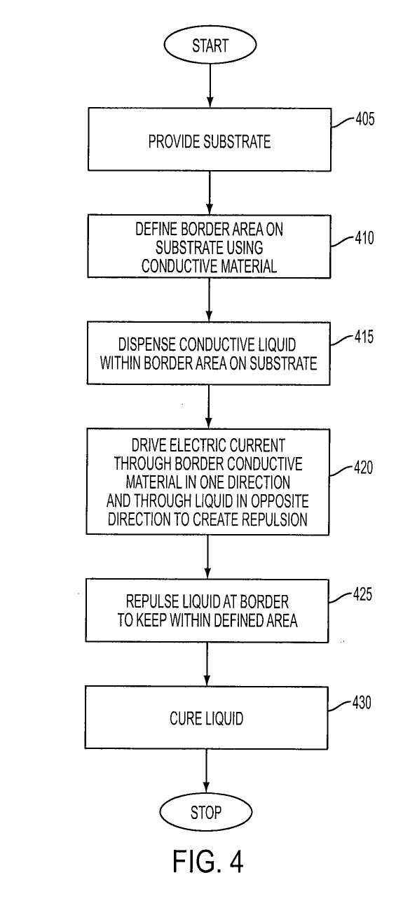

FIG. 4 illustrates an exemplary method for placing a liquid adhesive on a substrate using electrical repulsion according to various embodiments. In the example of FIG. 4, a substrate can be provided (405). The substrate can include conductive material on a surface and/or embedded within the substrate, where the conductive material can be disposed around the substrate border to define an area for dispensing liquid adhesive (410). The conductive material can be in the form of wires, traces, patterned thin film, layers, substances, and the like. A conductive liquid adhesive can be dispensed onto the substrate within the defined area (415). Electric current can be driven through the conductive material in one direction and through the liquid adhesive in an opposite direction to create repulsive force between the conductive material and the adhesive in order to control placement of the adhesive in the defined area (420). As the adhesive spreads toward the border of the substrate, the repulsive force can increase to an amount sufficient to repulse the adhesive at the border and keep the adhesive from spreading further (425). The adhesive can be cured in the defined area (430). In some embodiments, the adhesive can be cured in steps. In a first step, the adhesive can be pre-cured, in which either only the edges of the adhesive are cured or the entire adhesive is partially cured, i.e., without sufficient energy to affect a complete cure. In a second step, the adhesive can be completely cured. In alternate embodiments, the adhesive can be completely cured in a single step.

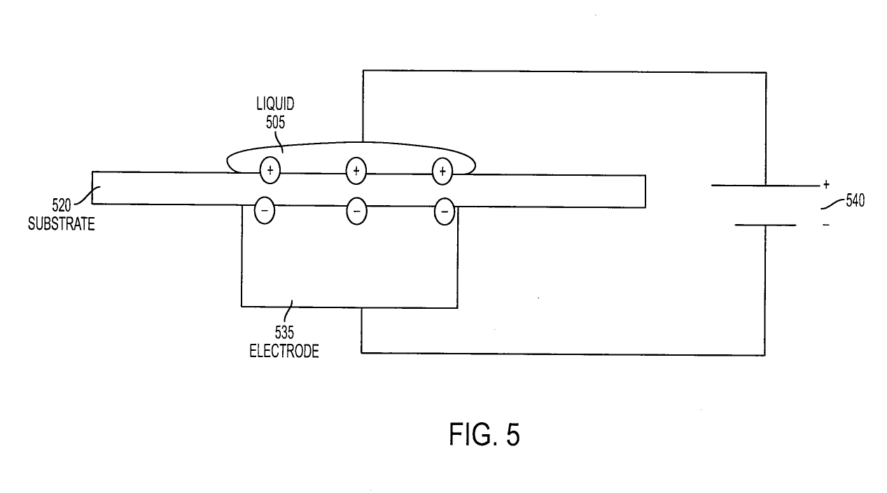

FIG. 5 illustrates an exemplary structure having a substrate with a liquid adhesive placed thereon using electrical attraction according to various embodiments. Electrical attraction can involve applying an electrical bias or voltage between proximate conductors that form the plates of a capacitor, thereby generating an attractive force between the two plates. In the example of FIG. 5, electrical attraction can be used to prevent a liquid adhesive from spreading beyond a desired area of a substrate.

Here, insulating substrate 520 can have electrode 535 disposed on one substrate surface and conductive liquid adhesive 505 dispensed on an opposite surface of the substrate. The shape and size of the electrode 535 can define an area of the substrate 520 within which to dispense the liquid adhesive 505. That is, the area of the substrate 520 upon which the electrode 535 is disposed can be the defined area. The dispensed adhesive 505 can initially form one or more liquid beads on the substrate 520. Voltage source 540 can apply a voltage to the electrode 535 to attract the bead(s) of liquid adhesive 505, where the adhesive can act as a plate of a capacitor formed with the electrode as the other plate. The attractive force can flatten the bead(s) of liquid adhesive 505 on the substrate 540 to conform to the shape and size of the electrode 535, thereby confining the adhesive to the defined area on the substrate.

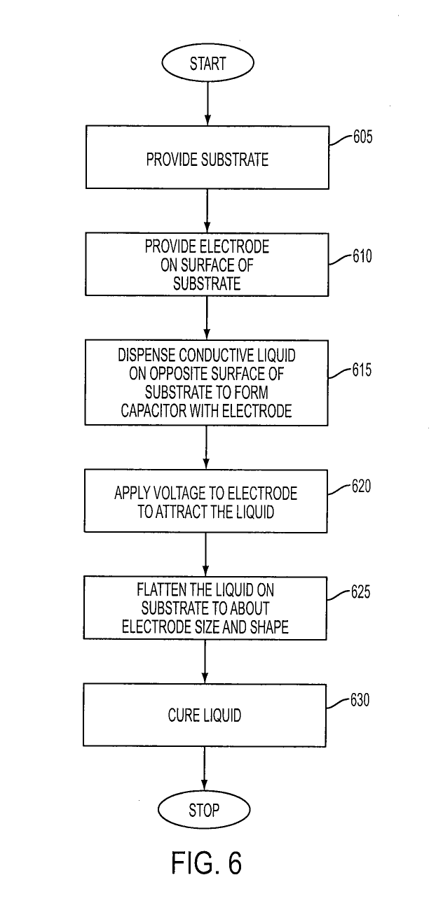

FIG. 6 illustrates an exemplary method for placing a liquid adhesive on a substrate using electrical attraction according to various embodiments. In the example of FIG. 6, an insulating substrate can be provided (605). An electrode can be provided which is disposed on a surface of the substrate, where the electrode can be a shape and size of a desired area for dispensing a liquid adhesive on the substrate (610). A conductive liquid adhesive can be dispensed onto a surface of the substrate opposite the surface on which the electrode is disposed, thereby forming a capacitor with the electrode (615). The adhesive can be dispensed on the substrate within the desired area. Voltage can be applied to the electrode to attract the liquid adhesive in order to control placement of the adhesive in the desired area (620). The attraction can cause the adhesive to spread and flatten on the substrate to about the size and shape of the electrode (625). The adhesive can be cured in the desired area (630).

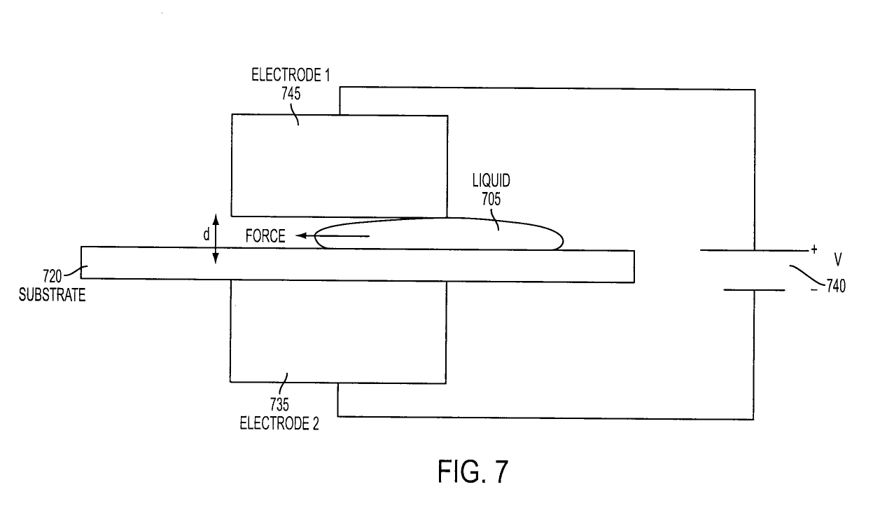

FIG. 7 illustrates an exemplary structure having a substrate with a liquid adhesive placed thereon using capacitance according to various embodiments. Capacitance can involve applying a bias voltage across proximate conductors that form the plates of a capacitor with a dielectric layer therebetween, where the capacitor plates can generate a force on the dielectric layer. In the example of FIG. 7, capacitance can be used to prevent a liquid adhesive from spreading beyond a desired area of a substrate.

Here, dielectric (or insulating) substrate 720 can have electrode 735 disposed on one substrate surface and electrode 745 positioned above an opposite substrate surface, forming a gap of width d between the two electrodes with the substrate positioned within the gap. Dielectric liquid adhesive 705 can be dispensed onto the substrate surface at the gap opening. The shape and size of the electrodes 735 and 745 can define an area of the substrate 720 within which to confine the liquid adhesive 705. The adhesive 705 can initially form one or more liquid beads on the substrate 720. Voltage source 740 can apply a bias voltage across the electrodes 735 and 745 to generate a capacitive force on the dielectric adhesive 705 that can pull the adhesive into the gap to conform to the shape and size of the electrodes 735 and 745, thereby confining the adhesive to the defined area on the substrate 720.

In an alternate embodiment, the dielectric substrate 720 and the electrode 735 can be replaced with a conductive substrate that can act as one of the plates of the capacitor formed with the electrode 745 as the other plate. As such, the gap width d can be reduced to be the distance between the conductive substrate and the electrode 745. The conductive substrate can itself be a conductive material or can have conductive material disposed on a surface or embedded within the substrate. Voltage source 740 can apply a bias voltage across the conductive substrate and the electrode 745 to generate a capacitive force on the dielectric adhesive 705 that can pull the adhesive into the gap, thereby confining the adhesive to the area on the conductive substrate defined by the shape and size of the electrode 745.

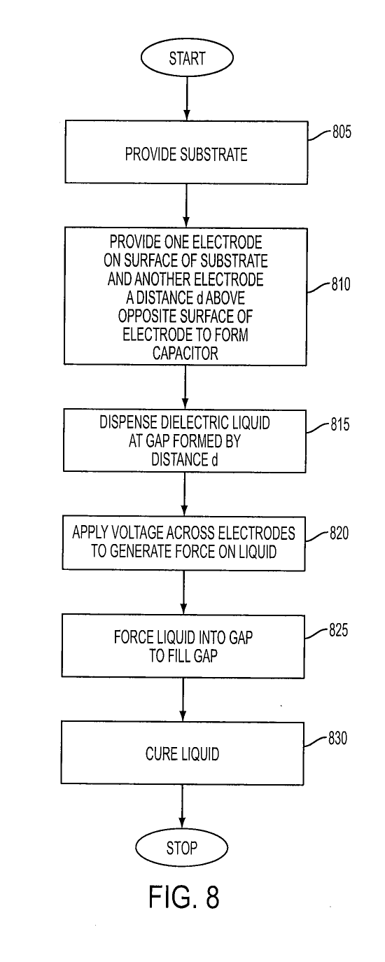

FIG. 8 illustrates an exemplary method for placing a liquid adhesive on a substrate using capacitance according to various embodiments. In the example of FIG. 8, a dielectric (or insulating) substrate can be provided (805). An electrode can be provided which is disposed on a surface of the substrate and another electrode can be provided which is disposed proximate to an opposite surface of the substrate, where the two electrodes can form a capacitor having a gap of width d between them (810). Either or both of the electrodes can be a shape and size of a desired area for dispensing a liquid adhesive on the substrate. A dielectric liquid adhesive can be dispensed onto the substrate surface at the gap (815). Bias voltage can be applied across the electrodes to generate a capacitive force on the dielectric adhesive in order to control placement of the adhesive in the desired area (820). The generated force can pull the adhesive into the gap to fill the gap and conform to about the size and shape of the electrode(s) (825). The adhesive can be cured in the desired area (830).

In an alternate method, in which the dielectric substrate and the electrode disposed thereon can be replaced with a conductive substrate, bias voltage can be applied across the conductive substrate and the electrode disposed proximate to the substrate to generate the capacitive force (820).

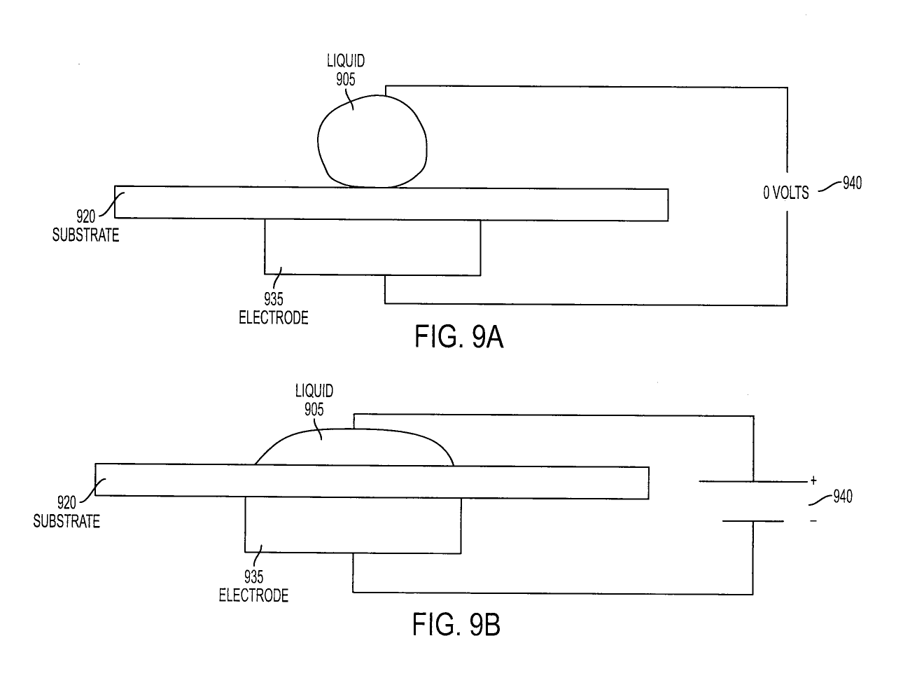

FIGS. 9a and 9b illustrate an exemplary structure having a substrate with a liquid adhesive placed thereon using electrowetting according to various embodiments. Electrowetting can involve applying a bias voltage to a hydrophobic surface to modify a contact angle of a liquid on the surface. Hydrophobic generally refers to a substance having little or no affinity for water. Example hydrophobic substances can include oils, fats, and the like. In the examples of FIGS. 9a and 9b, electrowetting can be used to prevent a liquid adhesive from spreading beyond a desired area of a substrate.

Here, hydrophobic substrate 920 can have electrode 935 disposed on orie surface of the substrate and conductive water-based liquid adhesive 905 dispensed on the opposite surface of the substrate. The substrate can itself be a hydrophobic material or can have a hydrophobic coating on its surface. Due to the hydrophobic nature of the substrate 920, the liquid adhesive 905 can form one or more beads on the substrate, thereby forming a high contact angle (and therefore small liquid footprint) on the substrate. The electrode 935 can be a shape and size of a desired area for dispensing a liquid adhesive on the substrate. Voltage source 940 can apply a bias voltage to the electrode 935, resulting in modification of the contact angle of the liquid adhesive 905 such that the adhesive contacts more of the substrate surface (i.e., flattens or expands on the surface to conform to the shape and size of the electrode 935) in the desired area. This can confine the adhesive 905 to the desired area of the substrate 920.

In an alternate embodiment, an oleophobic substrate 920 can be used with an oil-based liquid adhesive 905.

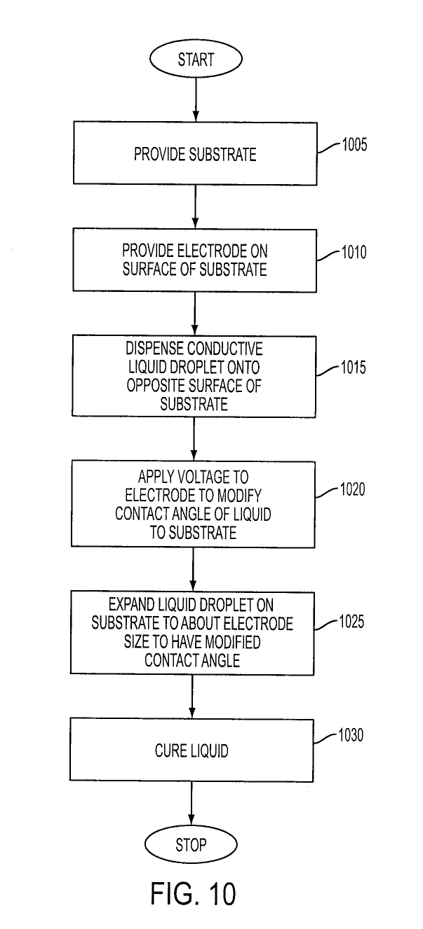

FIG. 10 illustrates an exemplary method for placing a liquid adhesive on a substrate using electrowetting according to various embodiments. In the example of FIG. 10, a hydrophobic substrate can be provided (1005). An electrode can be provided which is disposed on a surface of the substrate, where the electrode can be a shape and size of a desired area for dispensing a liquid adhesive on the substrate (1010). A conductive water-based liquid adhesive can be dispensed onto a surface of the substrate opposite the surface on which the electrode is disposed to form one or more droplets (or beads) on the substrate (1015). The adhesive can be dispensed on the substrate within the desired area defined by the electrode. Bias voltage can be applied to the electrode to modify the contact angle of the adhesive on the substrate in order to control placement of the adhesive in the desired area (1020). The adhesive droplet(s) (or bead(s)) can expand or flatten on the substrate to about the size and shape of the electrode (1025). The adhesive can be cured in the desired area (1030).

In an alternate method, in which an oleophobic substrate and a conductive oil-based liquid adhesive are used, bias voltage can be applied to modify the contact angle of the oil-based adhesive on the substrate (1020).

In some embodiments, the conductive liquid adhesive and/or the conductive substrate described above can electrically interfere with other device conductive components, e.g., conductive traces, to be disposed on or proximate to the adhesive and/or the substrate. To avoid such interference, the conductive liquid adhesive and/or the conductive substrate can be used in a device that does not require other conductive components. Alternatively, a dielectric liquid adhesive and/or dielectric substrate can be used instead of the conductive ones in a device that does require other conductive components.

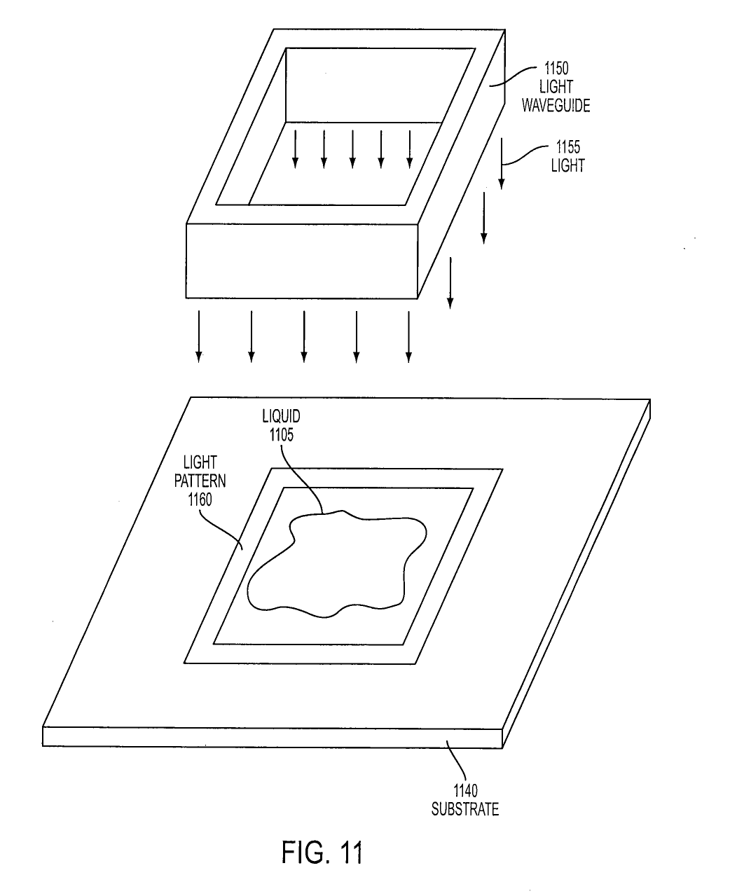

FIG. 11 illustrates an exemplary structure having a substrate with a liquid adhesive placed thereon using light curing according to various embodiments. Light curing can involve applying light (or some other electromagnetic radiation) to a light curable liquid adhesive, which solidifies the adhesive to stop it in place. In some embodiments, ultraviolet light can preferably be used to cure the liquid adhesive. In some embodiments, light can be applied to the edges of the adhesive to form barriers of the adhesive itself to stop further spreading. In some embodiments, light can be applied to the entire adhesive to stop it from spreading further. Light can be applied using a waveguide, a projector, an emitter, and other devices capable of controllably focusing light into desired areas of a substrate. In the example of FIG. 11, light curing can be used to prevent a liquid adhesive from spreading beyond a desired area of a substrate.

Here, substrate 1140 can have liquid adhesive 1105 dispensed on a substrate surface within a desired area. Light waveguide 1150 (or some other light emitting device) can be positioned proximate to the substrate 1140 and can emit light 1155 (or other electromagnetic radiation) to form pattern 1160 on the substrate surface that aligns with a border of a desired area for dispensing a liquid adhesive. Upon contacting the light pattern 1160 during spreading, the dispensed adhesive 1105 can be cured by the light 1155 to prevent further spreading, thereby confining the adhesive to the desired area of the substrate. In some embodiments, the liquid adhesive 1105 can spread naturally. In addition or alternatively, the liquid adhesive 1105 can spread with assistance from one or more of the above described phenomena, e.g., electrical repulsion, electrical attraction, capacitance, electrowetting, and the like.

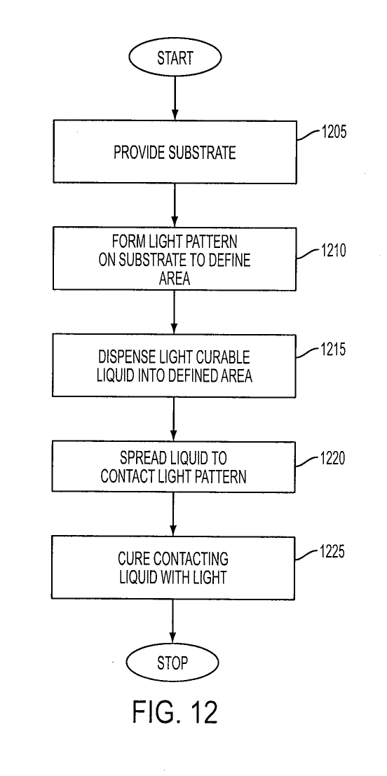

FIG. 12 illustrates an exemplary method for placing a liquid adhesive on a substrate using light curing according to various embodiments. In the example of FIG. 12, a substrate can be provided (1205). A light pattern can be formed on a surface of the substrate at a border of one or more areas defined for dispensing a liquid adhesive in order to control placement of the adhesive in the defined area(s) (1210). The pattern can be formed by light emitting from a light emitting device, e.g., a waveguide, a projector, an emitter, and the like, positioned proximate to the substrate. A light curable liquid adhesive can be dispensed within the defined area(s) on the substrate (1215). The adhesive can spread to contact the light pattern (1220). The contacting adhesive can be cured with the light (1225).

In an alternate method, before forming the light pattern, the liquid adhesive can be allowed to spread beyond the defined area on the substrate. The light can then be applied to the adhesive in the desired light pattern to cure the adhesive in contact with the light. The adhesive that spreads outside the light pattern can be removed.

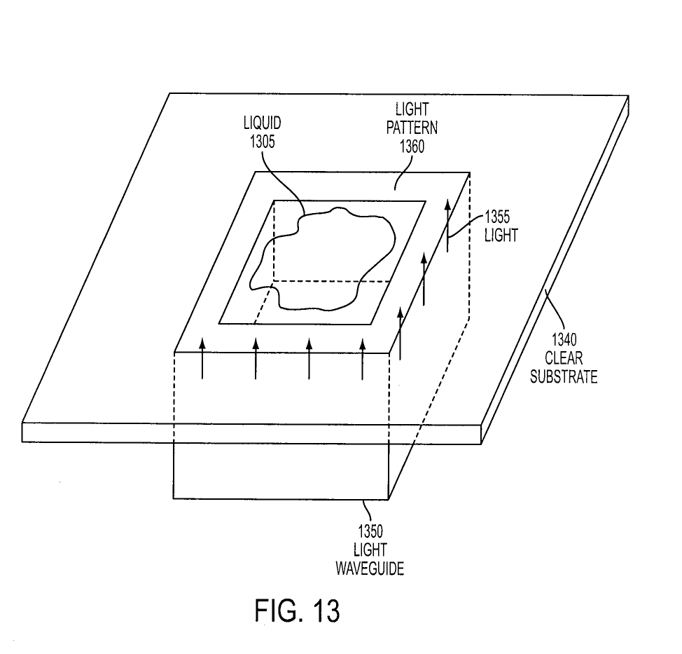

FIG. 13 illustrates another exemplary structure having a substrate with a liquid adhesive placed thereon using light curing according to various embodiments. In the example of FIG. 13, light permeable substrate 1340 can have light curable liquid adhesive 1305 dispensed on a substrate surface within a desired area. The substrate 1340 can be transparent, semi-transparent, or otherwise capable of transmitting light therethrough. Light waveguide 1350 (or some other light emitting device) can be positioned proximate to the opposite surface of the substrate 1340 and can emit light 1355 (or other electromagnetic radiation) that passes through the substrate to form pattern 1360 on the substrate surface aligned with a border of the one or more desired areas for dispensing a liquid adhesive. Upon contacting the light pattern 1360, the adhesive 1305 can be cured by the light 1355 to prevent further spreading, thereby confining the adhesive to the desired area(s) of the substrate. The liquid adhesive 1305 can be allowed to spread naturally and/or with assistance from one or more of the above described phenomena. In the example of FIG. 13, light curing can be used to prevent a liquid adhesive from spreading beyond a desired area of a substrate.

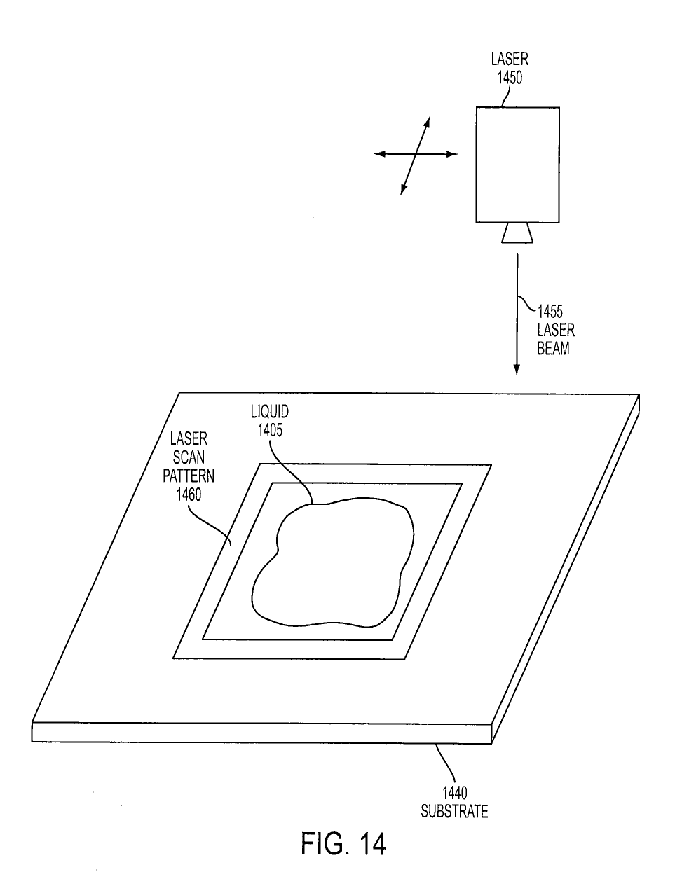

FIG. 14 illustrates an exemplary structure having a substrate with a liquid adhesive placed thereon using laser curing according to various embodiments. Similar to light curing, laser curing can involve applying a laser beam to a light curable liquid adhesive, which solidifies the adhesive to stop it in place. In some embodiments, the laser beam can be applied to the boundaries of the adhesive to form barriers of the adhesive itself to stop further spreading. In some embodiments, the laser beam can be applied to the entire adhesive to stop it from spreading further. In the example of FIG. 14, laser curing can be used to prevent a liquid adhesive from spreading beyond a desired area of a substrate.

Here, substrate 1440 can have light curable liquid adhesive 1405 dispensed on a substrate surface within a desired area. Laser 1450 can be positioned proximate to the substrate 1440 and can move along a desired scan path (e.g., longitude and/or transverse with respect to the substrate) and emit laser beam 1455 to form scan pattern 1460 on the substrate surface aligned with a border of the one or more desired areas for dispensing a liquid adhesive. Upon contacting the scan pattern 1460 during spreading, the adhesive 1405 can be cured by the laser beam 1455 to prevent further spreading, thereby confining the adhesive to the desired area(s) of the substrate. The liquid adhesive 1405 can spread naturally or can spread with assistance from one or more of the above described phenomena.

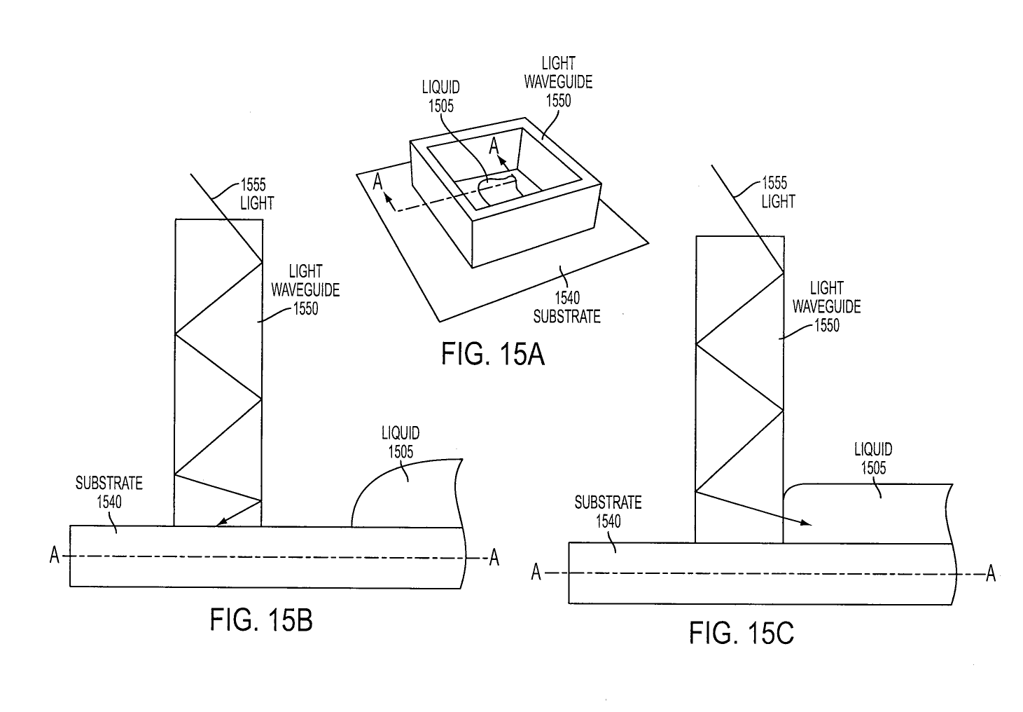

FIGS. 15a through 15c illustrate an exemplary structure having a substrate with a liquid adhesive placed thereon using total internal light reflection according to various embodiments. Total internal light reflection can involve a light transmission medium, e.g., a waveguide, which internally reflects any light therein when in contact with air and which leaks out some light when in contact with something else. This can be because the reflection angle of light within a transmission medium can be affected by the index of refraction of the material contacting the exterior of the medium. For example, an increase in the material's index of refraction can cause the light to leak out of the light transmission medium in contact with the material. When air is the contacting material, the transmission medium's light reflection angle can be such that all the light is reflected inside the medium. However, when some other material contacts the medium (i.e., a material having an index of refraction greater than air's index of refraction), the reflection angle can change such that some of the light is not internally reflected, but leaks out of the medium at the point of contact. In the example of FIGS. 15a through 15c, total internal light reflection can be used to prevent a liquid adhesive from spreading beyond a desired area of a substrate.

Here, light waveguide 1550 (or some other light transmission medium) can be disposed on a surface of substrate 1540 and aligned with a border of a desired area for dispensing a liquid adhesive. Light curable light adhesive 1505 can be dispensed within the desired area. Light 1555 (or some other electromagnetic radiation) can be transmitted through the light waveguide 1550 and internally reflected. When the liquid adhesive 1505 spreads to contact the waveguide 1550, some of the light 1555 can leak out of the waveguide into the liquid adhesive to cure the contacting adhesive, thereby confining the adhesive to the desired area of the substrate. The liquid adhesive 1505 can spread naturally or with assistance from one or more of the above described phenomena.

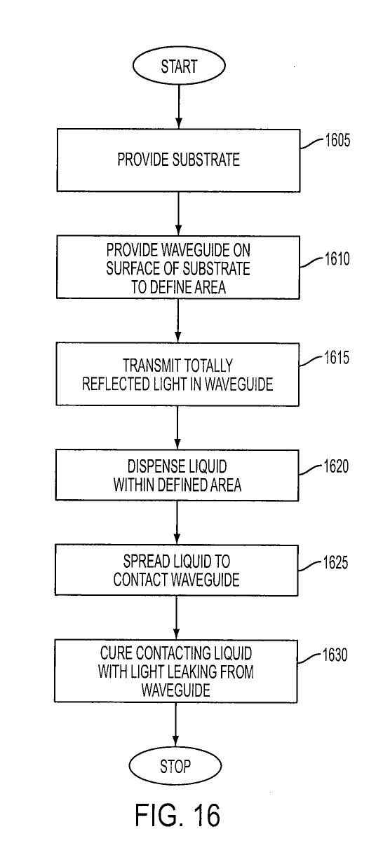

FIG. 16 illustrates an exemplary method for placing a liquid adhesive on a substrate using total internal light reflection according to various embodiments. In the example of FIG. 16, a substrate can be provided (1605). A light transmission medium, e.g., a waveguide, can be provided on a surface of the substrate and aligned with a border of an area defined for dispensing a liquid adhesive (1610). Light can be transmitted through the waveguide, where the light can be totally internally reflected (1615). Light curable liquid adhesive can be dispensed within the defined area onto the substrate (1620). The adhesive can spread in the desired area to contact the waveguide (1625). The adhesive can spread naturally and/or with assistance from one or more of the previously described phenomena. Upon contact with the waveguide during spreading, the adhesive can be cured by light leaking from the waveguide in order to control placement of the adhesive in the defined area (1630). The adhesive can have an index of refraction greater than the index of refraction of air. This increase in index of refraction when the adhesive displaces air upon contact with the waveguide can cause the light to leak out of the waveguide. That is, the total internal reflection angle of the waveguide when contacting air can be different from the total internal reflection angle of the waveguide when contacting the adhesive. In some embodiments, the waveguide can then be removed.

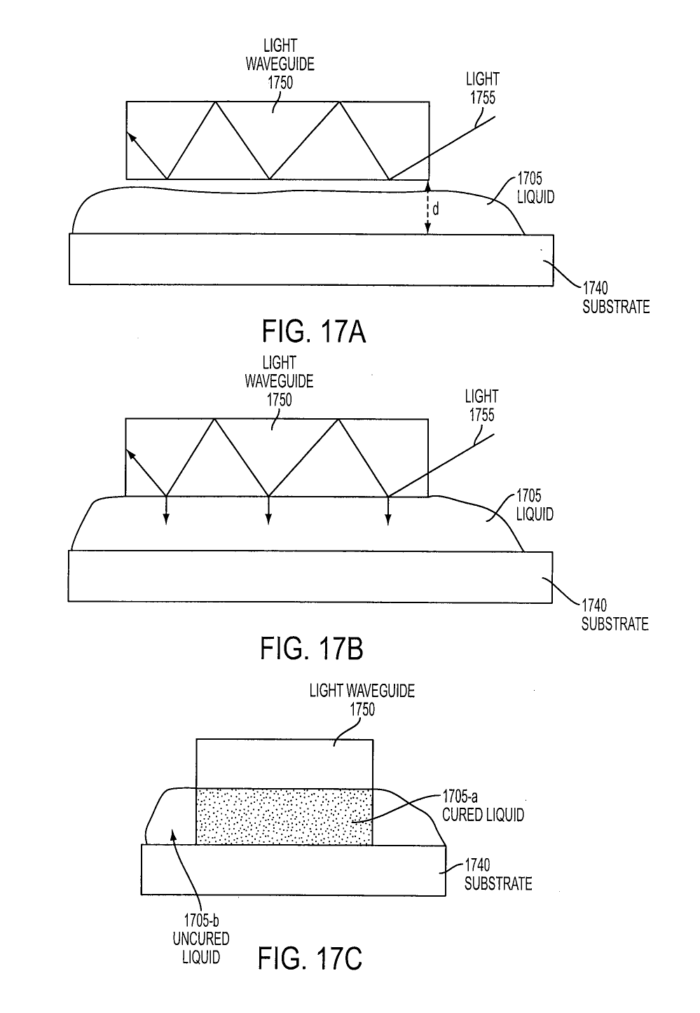

FIGS. 17a through 17c illustrate another exemplary structure having a substrate with a liquid adhesive placed thereon using total internal light reflection according to various embodiments. In the example of FIGS. 17a through 17c, light waveguide 1750 (or some other light transmission medium) can be positioned proximate to substrate 1740 at distance d, forming a gap between the substrate and the waveguide. The size and shape of the waveguide 1750 can define the desired area for dispensing liquid adhesive on the substrate. Light 1755 (or some other electromagnetic radiation) can be transmitted through the waveguide 1750 and internally reflected. Light curable liquid adhesive 1705 can be dispensed on the substrate 1740 to fill the gap between the waveguide 1750 and the substrate. Light 1755 leaked from the waveguide 1750 can cure the contacting adhesive 1705-a to conform to the shape and size of the waveguide. Portions of the adhesive 1705-b can spread beyond the waveguide 1750 and not be cured. These portions 1705-b can be removed by rinsing, wiping, dissolving, and the like. In some embodiments, the waveguide can be removed. The waveguide can have a non-stick coating on the surface in contact with the adhesive to prevent the adhesive sticking to the waveguide. In some embodiments, the waveguide can remain to act as a second substrate.

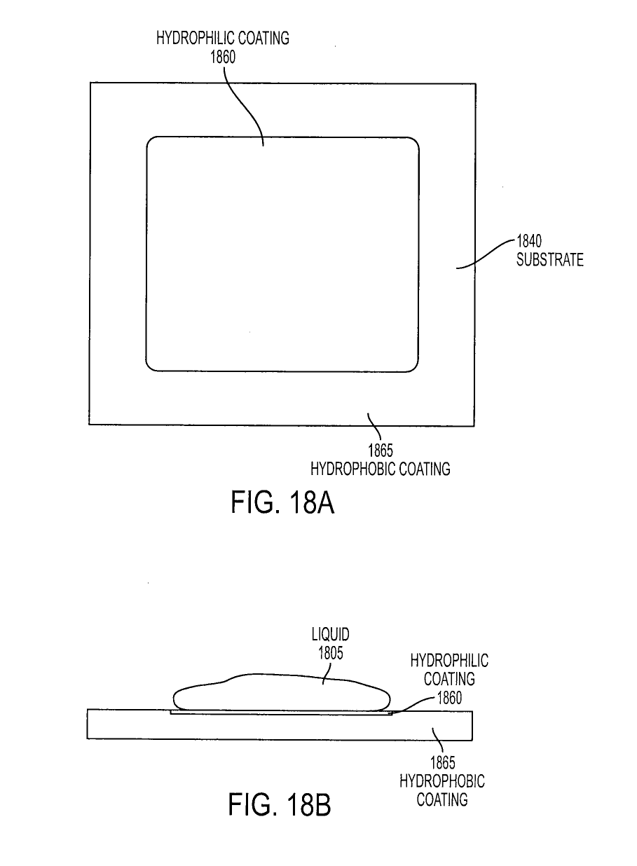

FIGS. 18a and 18b illustrate an exemplary structure having a substrate with a liquid adhesive placed thereon using hydrophilic and hydrophobic coating according to various embodiments. Hydrophobic is described above. Hydrophilic generally refers to a substance having an affinity for water. Example hydrophilic substances can include alcohols and the like. In the example of FIGS. 18a and 18b, substrate 1840 can have hydrophilic coating 1860 over a desired area of the substrate for dispensing a liquid adhesive therein and hydrophobic coating 1865 over the remaining areas of the substrate. Water-based liquid adhesive 1805 can be dispensed within the desired area. The hydrophilic nature of the coating 1860 and the hydrophobic nature of the coating 1865 can work together to prevent the adhesive 1805 from spreading beyond the hydrophilic area, thereby confining the adhesive to the desired area.

In an alternate embodiment, the hydrophilic coating can be omitted in the desired area and the remaining areas can have the hydrophobic coating to prevent the water-based liquid adhesive from spreading into the hydrophobic areas. In another alternate embodiment, the hydrophobic coating can be omitted and the hydrophilic coating can be strongly hydrophilic in the desired area to strongly attract the water-based liquid adhesive to the desired hydrophilic area.

In some embodiments, oleophilic and/or oleophobic coatings can be used on the substrate with an oil-based liquid adhesive. Other coatings with affinities associated with the adhesive can also be used. Oleophilic generally refers to a substance having an affinity for oils and oil-like compounds. Example oleophilic substances can include oils, fats, and the like. In contrast, oleophobic generally refers to a substance having little or no affinity for oils and oil-like compounds. Example oleophobic substances can include water and the like.

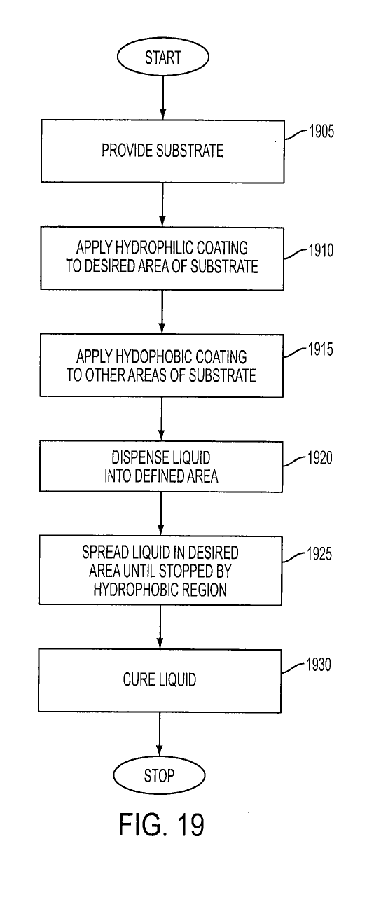

FIG. 19 illustrates an exemplary method for placing a liquid adhesive on a substrate using hydrophilic and hydrophobic coating according to various embodiments. In the example of FIG. 19, a substrate can be provided (1905). A hydrophilic coating can be applied to one or more desired areas on the substrate to define area(s) for dispensing a liquid adhesive thereon (1910). A hydrophobic coating can be applied to the remaining areas on the substrate (1915). The hydrophilic and hydrophobic coatings can be used to control placement of a liquid adhesive in the desired area(s). A water-based liquid adhesive can be dispensed in the desired hydrophilic area(s) of the substrate (1920). The adhesive can spread in the desired area(s) until it reaches the hydrophobic areas that prevent further spreading (1925). The adhesive can be spread naturally and/or with assistance from the previously described phenomena, for example. The adhesive can be cured (1930).

In an alternate method, in which oleophilic and oleophobic coatings and an oil-based liquid adhesive are used, the adhesive can be dispensed in the oleophilic areas of the substrate (1920) and can spread in these areas until it reaches the oleophobic areas that prevent further spreading (1925).

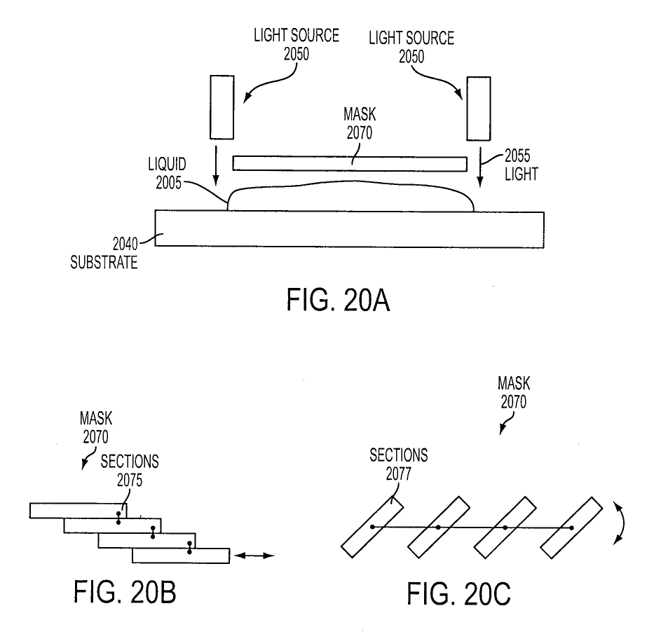

FIGS. 20a through 20c illustrate an exemplary structure having a substrate with a liquid adhesive placed thereon using a movable mask according to various embodiments. In the example of FIGS. 20a through 20c, movable mask 2070 can be disposed proximate to substrate 2040 and can have a dynamically adjustable shape and size of a desired area for dispensing a liquid adhesive onto a substrate. One or more light sources 2050 can also be disposed proximate to the substrate 2040 to emit light 2055 (or some other electromagnetic radiation) to cure a liquid adhesive on the substrate. The mask 2070 can be adjusted to be positioned in the path of the light 2055 to control where the light hits the liquid adhesive to cure the adhesive. Light curable liquid adhesive 2005 can be dispensed onto the substrate 2040 within the desired area. In some embodiments, as in FIG. 20b, the mask 2070 can have sliding sections 2075 that can slide backward, forward, and sideways to block some light 2055 from reaching and curing selective portions of the liquid adhesive 2005. In some embodiments, as in FIG. 20c, the mask 2070 can have rotating sections 2077 that can rotate backward, forward, and sideways to block some light 2055 from reaching and curing selective portions of the liquid adhesive 2005. The sections 2075 and 2077 can be adjusted manually, electrically, mechanically, electromechanically, and the like. A controller can be used to control the timing and movement of the mask sections 2075 and 2077.

In some embodiments, the mask 2070 can be stationary rather than movable. For example, the mask can be positioned proximate to areas of the substrate where a liquid adhesive dispensed on the substrate is not to be cured.

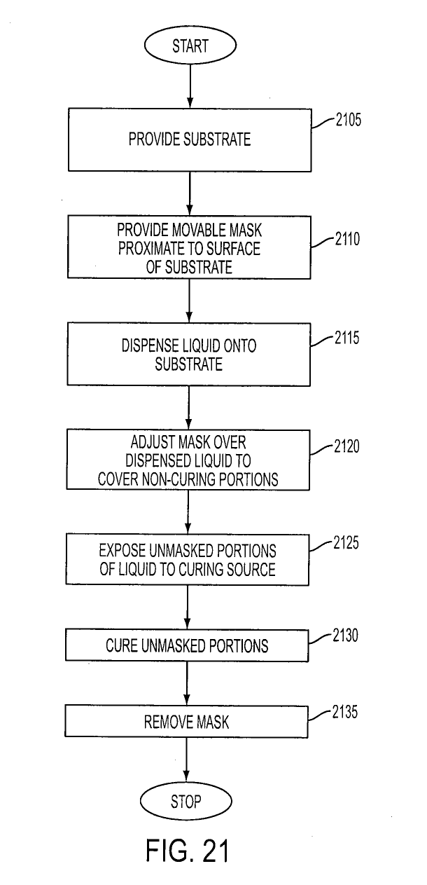

FIG. 21 illustrates an exemplary method for placing a liquid adhesive on a substrate using a movable mask according to various embodiments. In the example of FIG. 21, a substrate can be provided (2105). A movable mask can be provided proximate to a surface of the substrate (2110). The shape and size of the mask can be adjusted to correspond to a desired area on the substrate for dispensing a liquid adhesive. A light curable liquid adhesive can be dispensed onto the substrate surface proximate to the mask (2115). The mask can be adjusted over the dispensed liquid adhesive to cover selected portions of the adhesive not to be cured and to uncover selected portions of the adhesive to be cured in order to control placement of the adhesive in the desired area of the substrate (2120). In some embodiments, the uncovered portions can be at the border of the desired area to prevent further spreading of the adhesive. The uncovered portions of the adhesive can be exposed to light (or some other electromagnetic radiation) from the light sources (2125). The uncovered portions can be cured (2130). The mask can then be removed (2135).

In some embodiments, the mask can be dynamically adjusted as the dispensed liquid adhesive spreads on the substrate to cover and uncover selected portions of the adhesive either to cure or to protect from curing according to the desired placement of the adhesive on the substrate.

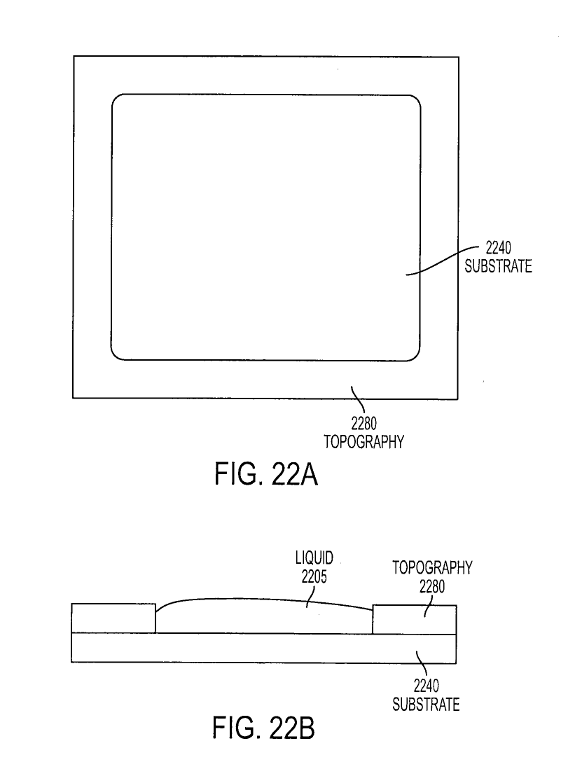

FIGS. 22a and 22b illustrate an exemplary structure having a substrate with a liquid adhesive placed thereon using topography of the substrate according to various embodiments. In the example of FIGS. 22a and 22b, substrate 2240 can have raised topography 2280 forming a barrier around a desired area for dispensing a liquid adhesive onto the substrate to prevent the adhesive from spreading beyond the desired area. In some embodiments, the raised topography 2280 can be a permanently affixed component on the substrate 2240, such as printed ink for a black mask. In some embodiments, the raised topography 2280 can be a portion of the substrate itself 2240. Liquid adhesive 2205 can be dispensed within the desired area of the substrate and confined therein by the raised topography 2280.

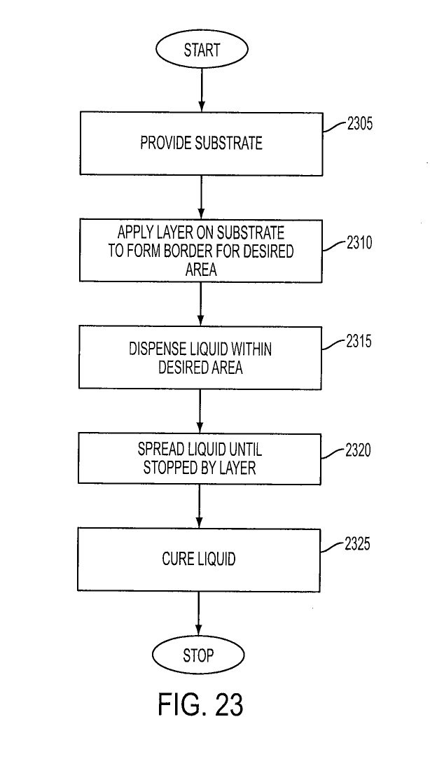

FIG. 23 illustrates an exemplary method for placing a liquid adhesive on a substrate using topography of the substrate according to various embodiments. In the example of FIG. 23, a substrate can be provided (2305). A layer can be permanently applied to the substrate to define a desired area for dispensing a liquid adhesive onto the substrate (2310). A liquid adhesive can be dispensed into the desired area (2315). The adhesive can spread until it is stopped by the layer (2320). The adhesive can spread naturally or with assistance from one or more of the previously described phenomena. The adhesive can be cured (2325).

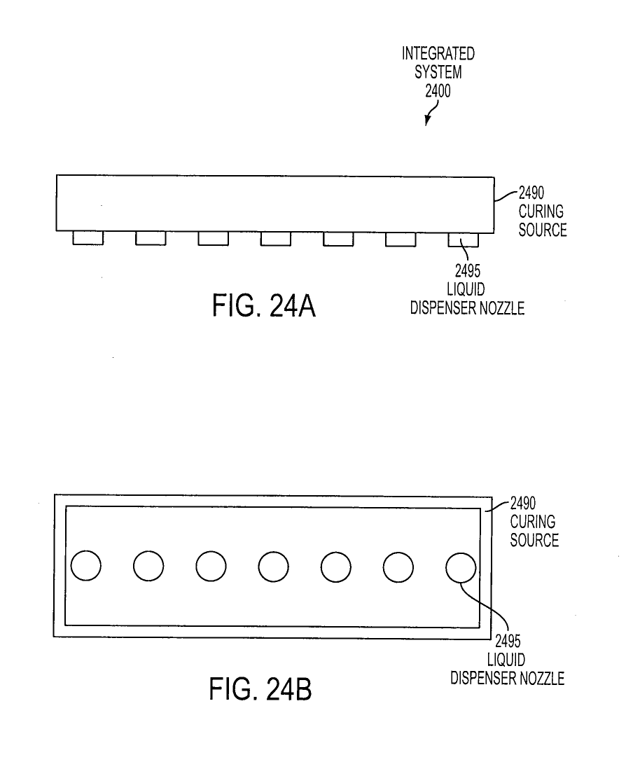

FIGS. 24a and 24b illustrate an exemplary system having an integrated liquid dispenser and curing source for controllably placing a liquid adhesive on a substrate according to various embodiments. In the example of FIGS. 24a and 24b, integrated unit 2400 can include one or more nozzles 2495 for dispensing liquid adhesive and curing source 2490 for curing the dispensed adhesive. The nozzles 2495 and the curing source 2490 can form an integrated unit. A controller (not shown) can control timing and movement of the unit to form a cured liquid adhesive on a substrate. The controller can be a microprocessor, a state machine, programmable logic, and the like. Multiple integrated units can be used together, where the units can move in different directions and/or at different times to dispense and cure liquid adhesive in one or more desired areas of the substrate.

In an alternate embodiment, the liquid adhesive can be dispensed using a ring, a line, a spot, or an area dispenser and so on according to placement needs.

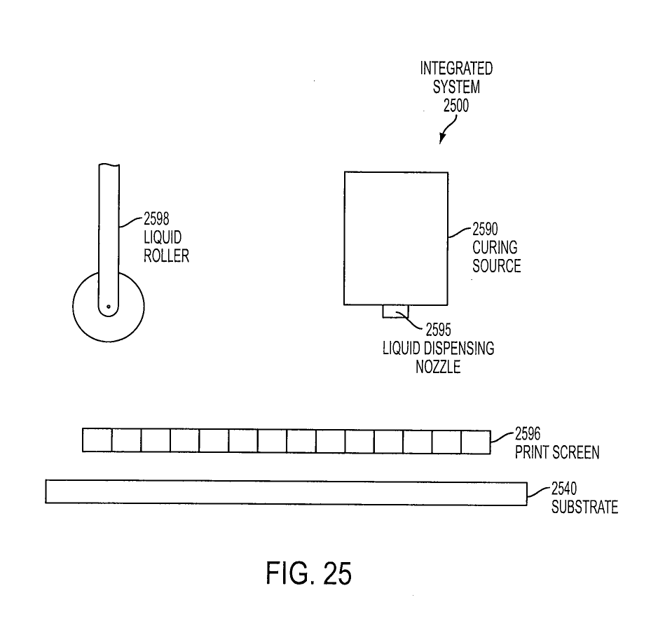

FIG. 25 illustrates an exemplary system having a print screen for controllably placing a liquid adhesive on a substrate according to various embodiments. In the example of FIG. 25, removable print screen 2596 can be placed on a surface of substrate 2540. The print screen 2596 can include a print pattern having a shape and size of a desired area for dispensing a liquid adhesive onto the substrate. Integrated unit 2500 can include one or more liquid dispenser nozzles 2595 to dispense liquid adhesive onto the print screen 2596 and curing source 2590 to cure the dispensed liquid adhesive. Liquid roller 2598. (or squeegee) can smooth the dispensed liquid adhesive on the print screen 2596 to push the liquid through the print pattern of the print screen onto the substrate 2540. The liquid roller 2598 can also roll over the print screen 2596 to clean the screen and remove any excess adhesive after the adhesive has been printed onto the substrate 2540 and the screen removed therefrom. A controller (not shown) can control timing and movement of the print screen, the integrated unit, and the liquid roller to print a liquid adhesive onto the substrate. Multiple integrated units and/or rollers can be used to move in different directions and/or at different times according to the adhesive placement needs.

It is to be understood that the structures and methods of FIGS. 3a through 23 can be used with the systems of FIGS. 24a through 25 to control placement of a liquid adhesive on a substrate. After the liquid adhesive has been controllably placed on the substrate in the desired area, the finished substrate can be removed from the structures and systems for further processing or use.

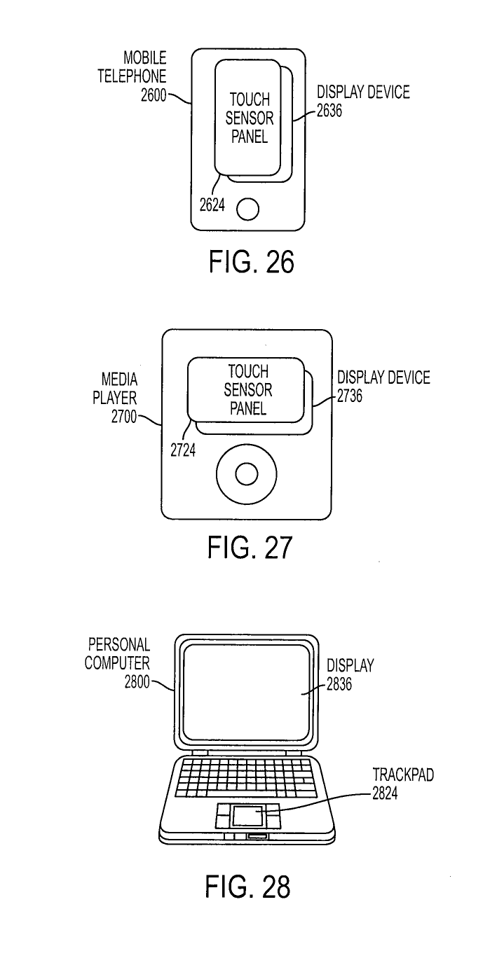

FIG. 26 illustrates an exemplary mobile telephone 2600 that can include a display 2636, a touch sensor panel 2624, and other components having a substrate with a liquid adhesive controllably placed thereon according to various embodiments.

FIG. 27 illustrates an exemplary digital media player 2700 that can include a display 2736, a touch sensor panel 2724, and other components having a substrate with a liquid adhesive controllably placed thereon according to various embodiments.

FIG. 28 illustrates an exemplary personal computer 2800 that can include a display 2836, a touch sensor panel (trackpad) 2824, and other components having a substrate with a liquid adhesive controllably placed thereon according to various embodiments.

The mobile telephone, media player, and personal computer of FIGS. 26 through 28 can realize quality performance by providing a structure having a substrate with a continuous, smooth adhesive formed thereon according to various embodiments.

Although embodiments describe liquid adhesives, it is to be understood that other liquids can be controllably placed on a substrate according to various embodiments.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A method comprising:
dispensing a liquid adhesive into a designated area on a surface of a substrate;
controllably applying energy to at least a portion of the dispensed liquid adhesive in the designated area to confine the dispensed liquid adhesive to the designated area; and
curing the confined liquid adhesive.

2. The method of claim 1, wherein controllably applying energy comprises applying at least one of electric current or voltage to the liquid adhesive to confine the liquid adhesive to the designated area.

3. The method of claim 1, wherein controllably applying energy comprises irradiating the liquid adhesive to confine the liquid adhesive to the designated area.

4. The method of claim 1, wherein curing the confined liquid adhesive comprises applying a heating source, a radiation source, or a cooling source to the liquid adhesive.

5. A method comprising:
electrically controlling placement of a liquid adhesive onto a surface of a substrate via electrical contact with the liquid adhesive; and
curing the placed liquid adhesive.

6. The method of claim 5, wherein electrically controlling placement of the liquid adhesive comprises:
driving a first electric current through a conductive pattern outlining a placement area on the surface of the substrate;
driving a second electric current in an opposite direction through the liquid adhesive placed within the placement area;
generating a repulsive force between the first and second electric currents; and
using the repulsive force to repulse the liquid adhesive from the conductive pattern so as to confine placement of the liquid adhesive to the placement area.

7. The method of claim 5, wherein electrically controlling placement of the liquid adhesive comprises:
disposing an electrode on an opposite surface of the substrate, the electrode having a shape corresponding to a placement area on the surface of the substrate;
applying a voltage to the electrode;
generating an attractive force between the electrode and the liquid adhesive placed within the placement area; and
using the attractive force to conform the liquid adhesive to the electrode shape so as to confine placement of the liquid adhesive to the placement area.

8. The method of claim 5, wherein electrically controlling placement of the liquid adhesive comprises:
disposing a first electrode on an opposite surface of the substrate;
disposing a second electrode proximate to the surface of the substrate to form a gap between the second electrode and the substrate surface,
wherein at least one of the first electrode or the second electrode has a shape corresponding to a placement area on the substrate surface;
applying a voltage across the first and second electrodes;
generating a capacitive force between the first and second electrodes to act on the liquid adhesive placed on the substrate surface at the gap; and
using the capacitive force to pull the liquid adhesive into the gap to conform to the electrode shape so as to confine placement of the liquid adhesive to the placement area.

9. The method of claim 5, wherein electrically controlling placement of the liquid adhesive comprises:
disposing an electrode on an opposite surface of the substrate, the electrode having a shape corresponding to a placement area on the surface of the substrate;
applying a voltage to the electrode; and
modifying a contact angle between the substrate and the liquid adhesive placed within the placement area in order to conform the liquid adhesive to the electrode shape so as to confine placement of the liquid adhesive to the placement area.

10. A method comprising:
dispensing a liquid adhesive onto a surface of a substrate; and
curing at least a portion of the dispensed liquid adhesive aligned with a border defining an area on the substrate for placement of the liquid adhesive.

11. The method of claim 10, wherein dispensing the liquid adhesive comprises electrically driving the liquid adhesive to spread on the substrate surface.

12. The method of claim 10, wherein curing the portion of the dispensed liquid adhesive comprises:
emitting light onto the substrate surface;
forming with the emitted light a light pattern on the substrate surface aligned with the border of the defined area; and
curing the dispensed liquid adhesive upon contact with the light pattern.

13. The method of claim 10, wherein curing the portion of the dispensed liquid adhesive comprises:
emitting light onto an opposite surface of the substrate, the substrate being light permeable;
forming with the emitted light a light pattern on the substrate surface aligned with the border of the defined area, the emitted light passing through the substrate from the opposite surface; and
curing the dispensed liquid adhesive upon contact with the light pattern.

14. The method of claim 10, wherein curing the portion of the dispensed liquid adhesive comprises:
emitting light onto the substrate surface;
scanning with the emitted light a pattern onto the substrate surface aligned with the border of the defined area; and
curing the dispensed liquid adhesive upon contact with the pattern.

15. The method of claim 10, wherein curing the portion of the dispensed liquid adhesive comprises:
disposing a light transmission medium on the substrate surface to align with the border of the defined area;
totally reflecting light within the medium;
leaking portions of the light to the liquid adhesive placed within the defined area as the liquid adhesive contacts the medium; and
curing the contacting liquid adhesive with the leaked portions of the light.

16. The method of claim 10, wherein curing the portion of the dispensed liquid adhesive comprises:
disposing a light transmission medium proximate to the substrate surface to form a gap between the medium and the substrate surface, a shape of the medium corresponding to the defined area;
totally reflecting light within the medium;
leaking portions of the light to the liquid adhesive placed within the gap to fill the gap as the liquid adhesive contacts the medium; and
curing the contacting liquid adhesive with the leaked portions of the light.

17. The method of claim 10, wherein curing the portion of the dispensed liquid adhesive comprises:
disposing a movable mask proximate to the substrate surface;
adjusting the movable mask to cover the defined area except at the border;
exposing the dispensed liquid adhesive at the border of the defined area to light; and
curing the exposed liquid adhesive.

18. The method of claim 10, comprising using at least one of an adhesive-attracting coating in the defined area or an adhesive-repulsing coating in remaining areas on the substrate surface to assist placement of the liquid adhesive in the defined area.

19. The method of claim 10, comprising using topography of the substrate to assist placement of the liquid adhesive in the defined area.

20. A structure comprising:
a substrate having a defined area; and
an adhesive filling the defined area, the adhesive having been controllably placed in the defined area in accordance with an adhesive characteristic that is compatible with the defined area.

21. The structure of claim 20, wherein the adhesive characteristic comprises at least one of conductivity, affinity, or curability.

22. The structure of claim 20 incorporated into at least one of a mobile phone, a digital media player, or a personal computer.

23. A liquid adhesive system comprising:
at least one integrated unit comprising
a dispenser configured to dispense a liquid adhesive into a designated area on a surface, and
a curing source disposed around at least a portion of the dispenser and configured to cure the dispensed liquid adhesive; and
a controller configured to control the integrated unit so as to confine placement of the liquid adhesive to the designated area.

24. The system of claim 23, further comprising:
a print screen configured to associate with the designated area on the surface so as to pass the dispensed liquid adhesive therethrough onto the surface; and
a roller configured to assist the dispensed liquid adhesive to pass through the print screen,
wherein the controller is configured to control the print screen and the roller.

25. The system of claim 23, comprising at least two integrated units configured to move differently around the designated area.
